(19) United States
(12) Patent Application Publication
(10) Pub. No.: US 2019/0001756 A1
(43) Pub. Date: Jan. 3, 2019

(54) SYSTEM FOR MONITORING THE CONDITION OF TYRES

(71) Applicant: Wriggle Solutions S.r.l.s., PISA (IT)

(72) Inventors: Arash GHOLAMZADEH NASRABADI, Empoli (Firenze) (IT); Alessio BALSINI, Volterra (Pisa) (IT); Davide CALVARESI, Castel di Lama (Ascoli Piceno) (IT)

(21) Appl. No.: 15/780,595

(22) PCT Filed: Dec. 2, 2016
(86) PCT No.: PCT/IB2016/057298

§ 371 Date: May 31, 2018

(30) Foreign Application Priority Data
Dec. 2, 2015 (IT) UB2015A006068

(51) Int. Cl. B60C 11/24

(52) U.S. Cl. CPC B60C 11/246

(57) ABSTRACT

A system for monitoring a condition of a tread of a tyre for vehicles may include: a sensor associated to at least a portion of the tread and consisting of extrinsically conductive polymers; a supply system of electric current able to provide electrical energy to the sensor; a data processing unit; and/or means for reading data of electrical resistance by the sensor and for transmitting the data to the data processing unit. The means for reading data may be able to continuously read variations of electrical resistance picked up by the sensor, which gives a measurement of wear of surface layers of the tyre in which the sensor is arranged. A set of algorithms may interpret the variations of the electrical resistance by comparison with reference data of the electrical resistance corresponding to a normal condition of the tread, to identify and quantify a condition of wear of the tread.

### FIELD OF THE INVENTION

The present invention concerns a system for monitoring tyres, which allows carrying out monitoring of the extent of wear in real time and quickly identifying particular conditions of wear of tyres that precede sudden failures or irreversible damages.

### STATE OF THE ART

In terms of road safety, tyres play a fundamental role. Tyres, and in particular their tread, indeed represent the only point of contact with the road surface that vehicles have, whatever their weight and size. The operating conditions and state of tyres, and in particular the thickness of their tread, can have a great impact on the performance of the vehicle on which they are mounted, and can be the cause of accidents, even serious ones, for example following sudden failure or bursting of the tyre.

A low thickness of the tread reduces the performance of the vehicle in terms of fuel consumption but also in terms of safety in extreme conditions, like sudden braking or driving in the wet: the control of the vehicle and grip indeed substantially decrease if the tyre is very worn and the thickness of the tread is low, while the probability of skidding increases due to aquaplaning. For this reason, there are legally set limits for the thickness of the tread, past which the tyre can no longer be used safely, and sanctions are imposed if the standard is not met. Despite this, checks carried out on vehicles in circulation constantly highlight the lack of attention that drivers pay to the condition of the tyres. For example, from over 9000 checks carried out in seven regions of Italy (Basilicata, Campania, Friuli Venezia Giulia, Marche, Molise, Lazio and Liguria) between mid-May and mid-June 2015, it was found that between 5 and 10% of the vehicles checked had a degree of wear of the tyres such as to be able to classify them as “bald tyres”, and over 3% of vehicles has tyres visibly damaged on the sidewalls. The problems that vehicles of this type can encounter, as stated above, range from increased fuel consumption, to low grip on a wet road or during braking, to the possibility of failure, bursting or breaking of the tyre during use with potentially disastrous consequences for the driver and passengers. Events like these, although currently commonly considered unpredictable and unavoidable, on the other hand to a large extent come down to wearing phenomena of the tyre.

For these reasons, it is essential to keep track of the degree of wear of the tyres mounted on vehicles. To do this, inside the grooves of the tread of the tyres there are generally projections distributed more or less evenly in the central area of the tread; such projections represent tyre wear indicators, making it possible to visually assess the extent of wear according to how low the depth of the grooves of the tread with respect to the projection appears to be. In practice, when, following wear, the grooves of the tread have reached in depth the thickness of the projections, it is necessary to replace the tyre. A system of this type, as well as being subject to a certain tolerance due to the visual assessment, also presumes awareness and a sense of responsibility of the driver, which unfortunately does not correspond to reality and in any case only indicates that the legal limit has been reached.

As far as the Applicant is aware, there is also currently only one other system effectively in use for checking the extent of wear of tyres, based on the use of special tyres equipped with coloured inserts in the body of the tyre having a colour contrasting with that of the compound of the tyre, at a height such that the coloured insert only becomes visible at the moment when the tread has reached the maximum tolerable wear limit. Such a system also clearly suffers from the same drawbacks highlighted above for the projections in the grooves of the tread, as well as the repercussions on the production process of the tyre. Examples of coloured indicators of this type are for example described in European patent application No. EP0312256 and in U.S. Pat. No. 5,704,999.

WO 2007/127220 describes a wireless sensor system for obtaining data from an elastomeric article.

US 2011/024010 describes tyres with enhanced performance that use active material actuation.

The state of the art also describes more or less complex systems for checking the condition of vehicle tyres, including their degree of wear, based for example on the use of accelerometers inside the tyre, to detect the instantaneous values of the acceleration and braking parameters, which are then compared with corresponding values in predetermined wear conditions of the tyre. As far as the Applicant is aware such systems have not yet found application in daily use of vehicles given their complexity and cost.

Therefore, there is still a great need in the field to have systems suitable for precisely and efficiently detecting the extent of wear of tyres in order to monitor in real time the condition of the tyres, optimising the performance of the vehicle, improving in general driving safety and also preventing sudden failure of tyres.

### SUMMARY OF THE INVENTION

The present invention thus proposes to provide a system for monitoring the condition of tyres that solves the problems highlighted above for known systems, making it possible to monitor in real time the wear of tyres and/or to detect their damage with a system having great precision and reliability, that does not rely on the will and awareness of the driver, with relative complexity and production cost. The system of the present invention is also applicable to any type of vehicle.

The main purpose of the present invention is therefore to provide a system that allows monitoring in real time the condition of wear of tyres for vehicles and/or to detect damage to them, even in cases in which wear and/or damage cannot be detected by the naked eye or with the systems currently known, and that at the same time does not excessively worsen the production costs of tyres and/or compromise the safety of vehicles.

This and other purposes are accomplished by the system for monitoring the condition of tyres for vehicles according to the present invention, whose essential characteristics are defined by the first of the independent claims attached hereto, by the related method and by the tyre having the essential characteristics respectively defined in independent claims 7 and 11.

Further important characteristics of the system, of the method and of the tyre according to the invention are defined in the dependent claims.

### BRIEF DESCRIPTION OF THE DRAWINGS

The characteristics and advantages of the system, of the method and of the tyre for monitoring the condition of tyres according to the invention, will become clearer from the following description of embodiments thereof given as a non-limiting example with reference to the attached drawings, in which:

FIG. 1 shows a tyre and some components of the system according to the present invention in an embodiment thereof;

FIG. 2 shows an operating diagram of the system of the present invention according to two different exemplary applications thereof.

### DETAILED DESCRIPTION

In the present invention, the term monitoring the “condition of a tyre” of a vehicle means monitoring the degree of wear of the tyre and/or possible damage thereto, carried out in real time while the vehicle is moving.

The system for monitoring the condition of tyres for vehicles according to the invention comprises:
a sensor associated with at least a portion of tread and based on extrinsically conductive polymers (or ECP);
a supply system of electric current, capable of supplying electrical energy to the aforementioned sensor;
a data processing central unit (or UCE);
means for reading data of electrical resistance in the aforementioned sensor, and for transmitting it to the aforementioned central unit;
set of algorithms for the interpretation of the data of electrical resistance detected by comparison with a reference data of electrical resistance corresponding to a normal condition of the tread, which does not have any sign of wear or damage, in order to identify and quantify a possible condition of wear of the tread.

In the present invention, the aforementioned interpretation of the detected data of electrical resistance by comparison with a reference data may be preferably carried out by filtering and data-processing techniques.

In the present invention the term “sensor associated with at least a portion of tread and based on extrinsically conductive polymers (or ECP)” means a portion of tread in which the polymer or the polymeric mixture of the compound of the tyre are doped with one or more conductive materials, as described in detail hereinafter, so as to create a portion consisting of ECP in the tread.

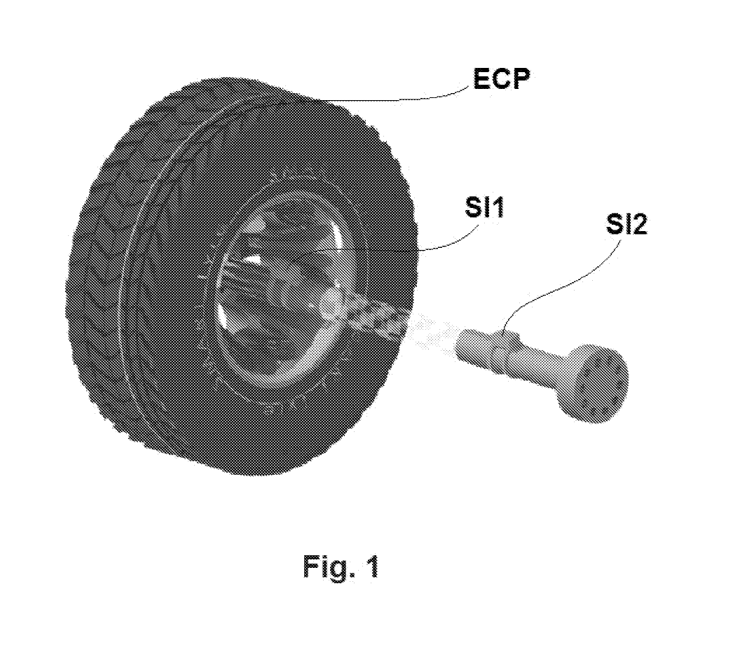

In a particular embodiment illustrated in FIG. 1, particularly suitable for monitoring, in addition to wear, possible damage to the tread of a tyre, the system of the invention also comprises at least two inertial sensors SI 1 and SI2 arranged in proximity to the hub of the wheel on which the tyre under monitoring is mounted at a predetermined distance between each other that depends on the type of vehicle, means for collecting data of frequency response read by such sensors and transmitting it to the aforementioned processing central unit, and a set of algorithms for the interpretation of such data at the aim of identifying possible damages to the tyre. More specifically, a first inertial sensor SI 1 is arranged as close as possible to the hub of the wheel, whereas a second inertial sensor SI2 is arranged in line with S11, typically in a position close to the centre of the vehicle.

The term “extrinsically conductive polymers” in the present invention means the polymers of the compound that normally constitutes the tyre suitably doped with one or more conductive materials, for example selected from electrically conductive metals and organic-based conductive materials, for example selected from the group consisting of copper, aluminium, gold, and conductive carbon-based materials, such as graphite and carbon nanotubes; a further example of conductive carbon-based material of possible use in the present invention is carbon black Preferred materials for the doping are carbon nanotubes. The percentage of doping conductive material can for example be comprised between 1% and 40% by weight with respect to the total weight of the composition of the tyre, preferably between 1% and 20% by weight and more preferably it is equal to about 10%; according to another preferred embodiment of the invention the percentage doping material is 5% by weight. In the system of the invention the tread of the tyre, or in any case its layers closest to the surface whose condition, i.e. the degree of wear and possible damage, it is wished to monitor, consist of an extrinsically conductive polymer as described above, so as to be able to be crossed by electric current giving a measurement of its electrical resistance that varies as a function of the amount of ECP crossed by the electric current, both in terms of section and in terms of length. On the other hand, the innermost part of the tyre, without doping, does not conduct the electric current or in any case has insignificant conductivity.

The sensor based on ECP according to an embodiment of the present invention can for example consist of rings of ECP in the surface layers of the tyre whose condition it is wished to monitor. According to an alternative embodiment of the present invention the sensor based on ECP can consist of multiple core samples of ECP immersed in the polymeric compound of the tyre. The sensor based on ECP can be evenly distributed in the whole tyre tread to be monitored, or only in its surface layers or in predetermined areas thereof.

A further aspect of the present invention concerns, in addition to the aforementioned system, also a tyre in which the tread or in any case the layers closest to the surface of the tyre, whose condition is wished to monitor, is associated with a sensor based on extrinsically conductive polymers (or ECP), with the specifications described above.

The system for supplying electric current comprised in the system of the invention is preferably a wireless supply system, i.e. a system that uses electromagnetic induction techniques to supply electrical energy to the sensor based on ECP with the purpose of measuring the electrical resistance thereof to the passage of current. Alternatively, the supply system of the system of the invention can for example be a power generator included in the tyre itself, whose energy, generated by the forces applied on the tyre during its rotation, it exploits. In another embodiment of the present invention, the system can be connected to a power generator installed on the rim of wheel via a wired link.

The means for reading and transmitting the data of electrical resistance to the processing central unit are comprised in the tyre and consist for example of a minimal processing unit with extremely low energy consumption that transmits the data read to the processing central unit via radio waves. The processing central unit analyses the data received in real time thanks to specific algorithms and mathematical models integrated in them.

According to a preferred embodiment of the system of the invention, the system also comprises at least one temperature sensor positioned inside the tyre and specific algorithms in the processing central unit for detecting and interpreting the temperature data detected.

The variation of electrical resistance picked up by the sensor based on ECP will give a measurement of the wear of the surface layers in which the sensor is arranged; in practice, thanks to a continuous reading of the values of electrical resistance of the sensor ECP, it will be possible to reconstruct any variation in the condition of the tread of the tyres.

An additional temperature sensor can be arranged inside the tyre in order to improve the accuracy of the measurement by introducing thermal models of electrical conductivity of the ECP. Such analysis is carried out in real time by specific algorithms (AU) carried out on the UCE.

With particular reference to the embodiment of FIG. 1, the system of the invention also comprises at least two inertial sensors arranged on the axis of the vehicle on which the tyre under evaluation is mounted; a first inertial sensor SI 1 is arranged in proximity to the hub of the wheel and a second inertial sensor SI2 is positioned at a variable distance from the first sensor SI 1 depending on the type of vehicle on which the present system is used. From these sensors, frequency signals of the vibrations are detected, in particular the data collected on the sensor SI 1 is used to produce a frequency analysis of the vibrations on the hub of the wheel, carried out in a differential manner with respect to the data collected by the sensor SI2 to exclude the noise produced by the inevitable vibrations of any moving vehicle and isolate only the component of vibrations of interest relative to the rotation of the wheel, and therefore of the tyre under monitoring, detected by the sensor S11. When the tyre in question is in a damaged condition or operates in non-ordinary conditions, the signal detected by the sensor SI 1 will have a new frequency content with respect to the natural one of the tyre that operate in ordinary conditions, and such a variation of the signal will be an indication of the condition of the tyre. A set of algorithms is comprised in the system in order to process the signals detected in real time and identify potential critical conditions of the tyre.

The present system is therefore capable of carrying out measurements and ensuring monitoring in real time the wear of a tyre and its relative performance degradation, as well as of identifying particular states and operating conditions of a tyre, i.e. damage, which can precede sudden failure, and/or irreversible damage to the tyre causing situations of danger to the vehicle and the passengers.

Thanks to the present system such disastrous consequences of failure or explosion of a tyre can be avoided and prevented, and more in general it is possible to prevent any inappropriate use of tyres mounted on a vehicle.

The data collected by the processing central unit described above can be aggregated and used for the following two main purposes:

1. real time notification to the driver of the vehicle of possible damage to one or more tyres, of anomalous operating conditions thereof and/or of a high degree of wear thereof through sound signals and/or indicators or lights on the dashboard of the vehicle;

2. transmission to a remote station for processing the data, for example to improve the management of fleets of company vehicles or to enable dedicated insurance policies, being able to obtain information from the data in question on the driving style of the driver, on possible collisions involving the vehicle, as well as tracking the route of the vehicle, and the like.

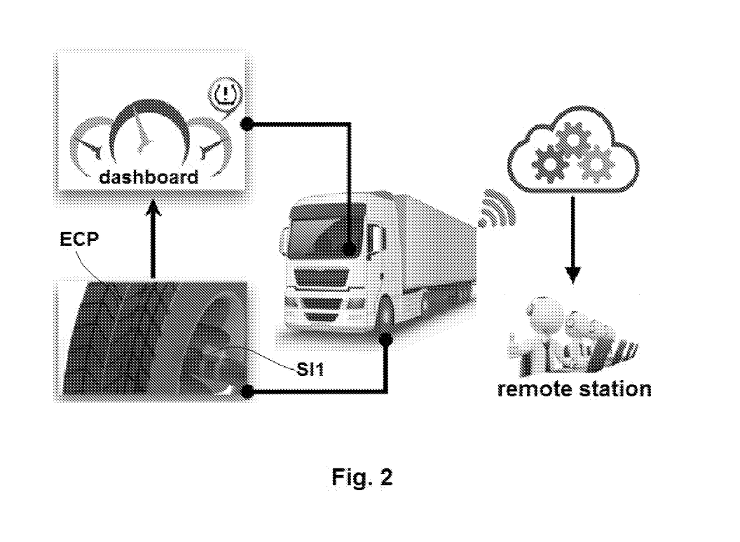

FIG. 2 schematically illustrates these two types of application, the left part of the figure representing the first application described above, i.e. notifying the driver of the vehicle, and the right part representing the transmission of data to a remote processing centre.

A further aspect of the present invention concerns a method for monitoring the condition of a tread of a tyre for vehicles, comprising the steps of:

i) passing an electric current in a sensor based on extrinsically conductive polymers (ECP) and associated with said tyre tread;

ii) acquiring continuously, periodically or sporadically, data of electrical resistance in said sensor, and transferring said data to a processing central unit; iii) comparing said measured data of electrical resistance with a reference data of electrical resistance corresponding to a normal condition, without any signs of wear and damages, of the tread and detecting said data variations.

Depending on the variation obtained between measured data and reference data, the method of the invention can provide for the emission of sound and/or light signals to signal possible variations between a measured data and the reference data that exceed a predetermined threshold.

According to a particular embodiment of the present invention, the method described above can also comprise the continuous acquisition of data of frequency response detected by inertial sensors arranged in proximity to the hub of the wheel on which the tyre under monitoring is mounted, and comparing it with a reference data corresponding to a normal condition to detect possible variations. Depending on whether such variations exceed a predetermined threshold value the method may or may not also comprise a step of emitting sound and/or light signals to signal such variations.

A first and main advantage of the system and method according to the present invention is given by the ability to provide precise data in real time of the wear of the tyres mounted on a vehicle, so as to increase the awareness of the driver of the degree of reliability of the tyres of his vehicle, also being able to detect conditions of wear or damage of tyres undetectable with current systems found on the market, and not visible to the naked eye. Consequently, a further advantage of the present system and method is the prevention of accidents caused by tyres operating in non-ordinary conditions, which reduce the grip thereof to the road surface, increasing braking distance and skidding due to aquaplaning, to the point of causing failure of the tyre itself in the most serious cases.

A further advantage of the system of the present invention is represented by the fact that all of the components of the system represent an optimal compromise between the requirements of quality and a relatively low cost.

Yet another advantage of the system of the present invention is represented by the fact that the data provided by the system can be collected and used for statistical and research purposes in the design and manufacture of innovative tyres having improved performance.

Yet another advantage of the system of the present invention is represented by the fact that the data provided by the system can be used not only to signal to the driver in real time, as described above, but can also be collected and transmitted to a data processing centre, for example in order to improve the management of fleets of company vehicles or to enable dedicated insurance policies, by monitoring the driving style of the driver, detecting collisions, tracing the route of the vehicle, and so on.

The last but not less important advantage is the monitoring of the condition of the tyres aimed at reducing fuel consumption, and therefore also polluting emissions released by the vehicle, as well as reducing operating costs.

The present invention has been described up to here with reference to a preferred embodiment. It should be understood that there may be other embodiments deriving from the same inventive core, as defined by the scope of protection of the claims given hereinafter.

1. A system for monitoring a condition of a tread of a tyre for vehicles, the system comprising:
a sensor associated to at least a portion of the tread and consisting of extrinsically conductive polymers (ECP);
a supply system of electric current able to provide electrical energy to the sensor;
a data processing central unit; and
means for reading data of electrical resistance by the sensor and for transmitting the data to the data processing central unit;
wherein the means for reading data are able to continuously read variations of electrical resistance picked up by the sensor, which gives a measurement of wear of surface layers of the tyre in which the sensor is arranged, and
wherein a set of algorithms interpret the variations of the electrical resistance by comparison with reference data of the electrical resistance corresponding to a normal condition of the tread, to identify and quantify a condition of wear of the tread.

2. The system of claim 1, further comprising:
at least two inertial sensors able to measure data of frequency response of vibrations at a hub of a wheel, on which wheel the tyre is mounted;
means for collecting the data of the frequency response detected by the at least two inertial sensors and for transmitting the data to the data processing central unit; and
a set of algorithms for interpreting the data of the frequency response by comparison with reference data of the frequency response corresponding to a normal condition of the tread, to identify possible damage.

3. The system of claim 1, wherein the sensor based on the ECP consists of the at least the portion of the tread, whose condition is under monitoring, and
wherein a polymer or polymeric mixture of the tyre is doped with one or more conductive materials.

4. The system of claim 3, wherein the polymer or polymeric mixture is doped with the one or more conductive materials selected from the group consisting of copper, aluminum, gold, and conductive carbon-based materials.

5. The system of claim 3, wherein the polymer or polymeric mixture is doped with carbon nanotubes.

6. The system of claim 3, wherein the polymer or polymeric mixture is doped with the one or more conductive materials in an amount of approximately 10% by weight with respect to a total weight of the polymer or polymeric mixture.

7. A method for monitoring a condition of a tread of a tyre for vehicles, the method comprising:
letting an electrical current flow in a sensor based on extrinsically conductive polymers (ECP) and associated to the tread of the tyre;
continuously reading variations of electrical resistance picked up by the sensor, which gives a measurement of wear of surface layers of the tyre in which the sensor is arranged, and transferring the data to a data processing central unit; and
comparing the variations of the electrical resistance with reference data of the electrical resistance corresponding to a normal condition of the tread, without any signs of wear and damage, and detecting data variations.

8. The method of claim 7, further comprising:
acquiring continuously data of frequency response detected by inertial sensors positioned at a hub of a wheel, on which wheel the tyre under monitoring is mounted; and
comparing the data of the frequency response with reference data corresponding to the normal condition of the tread and detecting possible variations.

9. The method of claim 8, further comprising:
emitting sound and/or light signals to a driver of the vehicle that signal possible variations between the data of the electric resistance and/or the data of the frequency response and the respective reference data, which variations exceed a predetermined threshold.

10. The method of claim 8, further comprising:
transmitting the data of the electrical resistance and/or the data of the frequency response and of the possible variations with respect to respective reference data to a remote station for data processing.

11. A tyre, comprising:
a sensor associated to at least a portion of tread of the tyre;
wherein the sensor consists of extrinsically conductive polymers (ECP).

12. The tyre of claim 11, wherein the sensor based on ECP consists of a portion of the tread, whose condition is under monitoring, and
wherein a polymer or polymeric mixture of the tyre is doped with one or more conductive materials.

13. The tyre of claim 12, wherein the polymer or polymeric mixture is doped with one or more conductive materials selected from the group consisting of copper, aluminum, gold, and conductive carbon-based materials.

14. The tyre of claim 12, wherein the polymer or polymeric mixture is doped with carbon nanotubes.

15. The tyre of claim 12, wherein the polymer or polymeric mixture is doped with one or more conductive materials in an amount of approximately 10% by weight with respect to a total weight of the polymer or polymeric mixture.

16. The system of claim 3, wherein the polymer or polymeric mixture is doped with one or more of copper, aluminum, gold, or conductive carbon-based materials.

17. The system of claim 1, wherein a polymer or polymeric mixture of the tyre is doped with one or more conductive materials.

18. The system of claim 17, wherein the polymer or polymeric mixture is doped with one or more of copper, aluminum, gold, or conductive carbon-based materials.

19. The system of claim 17, wherein the polymer or polymeric mixture is doped with carbon nanotubes.

20. The system of claim 17, wherein the polymer or polymeric mixture is doped with the one or more conductive materials in an amount of approximately 10% by weight with respect to a total weight of the polymer or polymeric mixture.
